(19) United States
(12) Patent Application Publication
(10) Pub. No.: US 2015/0199400 A1
(43) Pub. Date: Jul. 16, 2015

(54) AUTOMATIC GENERATION OF VERIFICATION QUESTIONS TO VERIFY WHETHER A USER HAS READ A DOCUMENT

(71) Applicant: KONICA MINOLTA LABORATORY U.S.A., INC., San Mateo, CA (US)

(72) Inventor: Philip WU, San Francisco, CA (US)

(73) Assignee: KONICA MINOLTA LABORATORY U.S.A., INC., San Mateo, CA (US)

(21) Appl. No.: 14/156,152

(22) Filed: Jan. 15, 2014

(51) Int. Cl. G06F 17/30; G09B 7/07; G09B 7/02

(52) U.S. Cl. CPC G06F 17/30401; G09B 7/02; G09B 7/07; G06F 17/30598

(57) ABSTRACT

A method for automatically analyzing the text of a document to generate verification questions to be administered to a user as a quiz for the purpose of verifying whether the user has read the document. Syntactic analysis is applied to statements (e.g. sentences) in the text to automatically generate various types of verification questions, including fill-in-the-blank, true/false, and multiple-choice questions. Nouns and proper nouns in a statement may be used to generate fill-in-the-blank questions; numerical values may be used to generate fill-in-the-blank, true/false and multiple-choice questions; and verbs, adjectives and adverbs may be used to generate true/false questions. The questions may be generated dynamically for each user, or generated once, stored and used for multiple users.

### BACKGROUND OF THE INVENTION

1. Field of the Invention

This invention relates to document processing, and in particular, it relates to a method for automatically analyzing the text of a document to generate verification questions to be administered to a user as a quiz for the purpose of verifying whether the user has read the document.

2. Description of Related Art

Many organizations, such as businesses and universities, often distribute written materials to their user base, such as employees or students. Increasingly, written materials are distributed digitally, often through an organization-specific intranet, web portal, learning management system, etc. Quite often, these organizations need a simple way of verifying that important distributed material has been read and understood by their user base. A conventional way of verifying that a user has read and understood a given material is by having the user take a quiz which contains verification questions related to the content of the distributed material. The quiz is typically generated by a human administrator (e.g. the author of the material or other persons familiar with the material). The administrator creates a set of various questions related to the document for verification, and creates a related answer bank so that the user's answer can be compared against it. This can prove to be a challenge when the amount of material distributed by an organization is large.

### SUMMARY

Thus, it would be advantageous for many organizations to have an automatic system of generating both verification questions and their associated answer banks. Such a system will save administrative time of the organization and achieve the goal of encouraging their user base to properly review and understand distributed material.

Accordingly, the present invention is directed to a method and related apparatus for automatically generating verification questions that substantially obviates one or more of the problems due to limitations and disadvantages of the related art.

An object of the present invention is to provide a fast and low-cost way of generating quizzes related to given reading materials.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a data processing apparatus for automatically processing text of a document to generate verification questions and associated correct answers, which includes: (a) parsing the text into statements and selecting a plurality of the statements; and (b) for each selected statement, generating a verification question and associated correct answer by performing one of the following steps: (b1) generating a modified statement by omitting one or more selected words or phrases from the statement and inserting blanks in their places, wherein the modified statement constitutes a fill-in-the-blank type of verification question and the omitted words or phrases constitutes the associated correct answer; (b2) either modifying the statement by replacing a selected word or phrase in the statement with another word or phrase that is a negated form or an antonym of the selected word or phrase, or keeping the statement unmodified, wherein the modified or unmodified statement constitutes a true/false type of verification question and the associated correct answer is False if the statement is modified and True if the statement is unmodified; and (b3) generating a modified statement by omitting one or more selected words or phrases from the statement and inserting blanks in their places, and generating a list of choices for each blank including a correct choice and one or more incorrect choices, wherein the modified statement and the lists of choices constitute a multiple-choice type of verification question and the correct choices constitute the associated correct answer; whereby a plurality of verification questions and associated correct answers are generated.

Step (b) may further include: parsing the statement into a plurality of words or phrases; and categorizing a selected one of the words or phrases into one of a plurality of grammatical categories comprising noun, proper noun, numerical value, verb, adjective, adverb, and common word, wherein if the word or phrase is a noun or proper noun, step (b 1) is performed, if the word or phrase is a numerical value, step (b1), (b2) or (b3) is performed, if the word or phrase is a verb, step (b2) is performed by replacing the verb with its negated form or keeping the statement unmodified, if the word or phrase is an adjective or adverb, step (b2) is performed by replacing the adjective or adverb with an antonym or keeping the statement unmodified, and if the word is a common word, repeating the categorizing step using another selected one of the words or phrases.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a method for automatically generating verification questions for a text document according to an embodiment of the present invention.

FIG. 2 schematically illustrates a process for distributing reading materials to a user and using a quiz to verify that the user has read the material.

FIGS. 3A and 3B show sample text used to explain embodiments of the present invention.

FIG. 4 schematically illustrates a data processing apparatus in which embodiments of the present invention may be implemented.

### DETAILED DESCRIPTION OF PREFERRED EMBODIMENTS

Embodiments of the present invention provide a method for automatically analyzing the text of a document to generate verification questions to be administered to a user as a quiz for the purpose of verifying whether the user has read the document.

The methods described here can be implemented in a data processing system such as a server computer 120 as shown in FIG. 4. The computer 120 comprises a processor 121, a storage device (e.g. hard disk drive) 122, and an internal memory (e.g. a RAM) 123. The storage device 122 stores software programs, which are read out to the RAM 123 and executed by the processor 121 to carry out the methods. The server computer is connected to an appropriate network (not shown). In one aspect, the invention is a method carried out by a data processing system. In another aspect, the invention is computer program product embodied in computer usable non-transitory medium having a computer readable program code embedded therein for controlling a data processing apparatus to carry out the method. In another aspect, the invention is embodied in a data processing system.

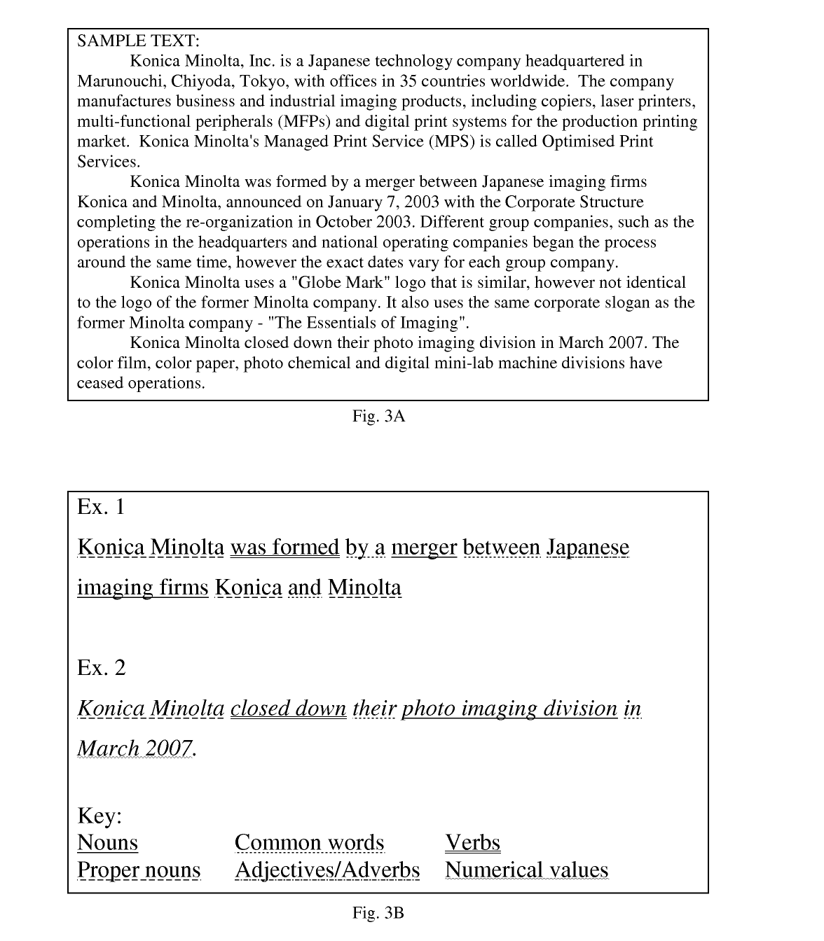

According to embodiments of the present invention, syntactic analysis is applied to statements (e.g. sentences) in the document text to automatically generate various types of verification questions. These various types of verification questions are explained using the sample text shown in FIG. 3A. The following types of verification questions may be automatically generated:

(1) Fill-in-the-Blank. One form of automatically generated verification questions is a “fill-in-the-blank” type of question, where certain keywords are omitted from a statement which is then presented to the user with blanks. To correctly answer the questions, the user must enter the proper words for the blanks. This type of question requires a minimal amount of logic to generate, and aside from removing the keywords, no manipulation of the original statement is required. The correct answer consists of the words that have been omitted.

Exemplary fill-in-the-blank question:

“Konica Minolta was formed by a merger between Japanese imaging firms ______ and ______.”

Correct answer: “Konica” and “Minolta”.

(2) True/False. Another form of automatically generated verification questions is one that requires a True/False answer. It can be generated by either presenting a statement parsed from the document text to the user without change, in which case the correct answer will be True, or by negating a verb found within the statement and presenting the modified statement to the user, in which case the correct answer will be False. To negate a verb found in the statement, logic is applied to the statement to find the verb, and then changing the verb found in the statement to a negated form (if the verb in the statement is a negative form, it is negated into a positive form). For the modified statement, an antonym for the verb in the original statement is also useful. True/False questions can also be generated based on adjectives or adverbs in a statement, where the word is either used as-is (True) or replaced by an antonym (False). True/False questions can also be generated based on numerical values in the statement, where the word is either used as-is (True) or replaced by another value (False). The replacement of the value is preferably achieved by using different value existing in the same statements.

Exemplary True/False question:

“Konica Minolta was formed by a merger between Japanese imaging firms Konica and Minolta.”

Correct answer: True.

Exemplary True/False question:

“Konica Minolta was not formed by a merger between Japanese imaging firms Konica and Minolta.”

Correct answer: False.

(3) Multiple-choice. A multiple-choice question is automatically generated by omitting certain word(s) or phrase(s) from a statement, and automatically generating a list of choices for each omitted word/phrase. The list of choices includes one correct choice and one or more incorrect choices. The modified statement and the lists of choices are presented to the user, and the correct answer will be the correct choice for each blank. The list of choices may be automatically generated by using words similar to, to the opposite of, or in the same category as the omitted word. One easy way to achieve this is to choose a numerical value in the statement, such as number, date/time (including names of months and days), price, etc., as the omitted word; the list of choices can include different values. Another type of words that may be used to generate multiple-choice questions is proper nouns. The logic can be expanded beyond these categories of words.

Another approach is to store a list of words on the computer, and when a statement contains one of the words in the list, that word may be chosen as the omitted word to generate a multiple-choice question. The list of words may be customized, so different organizations may choose different word lists.

Exemplary multiple-choice question:

“Konica Minolta, Inc. is a ______ technology company headquartered in Marunouchi, Chiyoda, Tokyo, with offices in ______ countries worldwide.
First blank: (a) American; (b) Japanese; (c) French; (d) Chinese
Second blank: (a) 10; (b) 3; (c) 35; (d) 50”

Correct answers: (b) and (c).

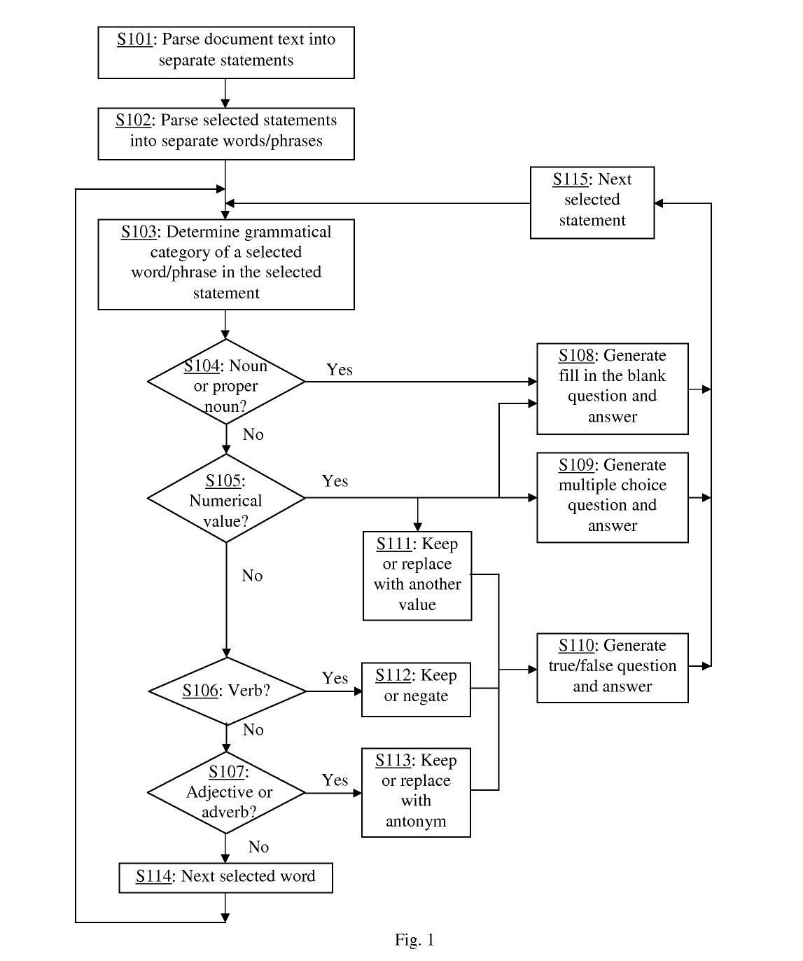

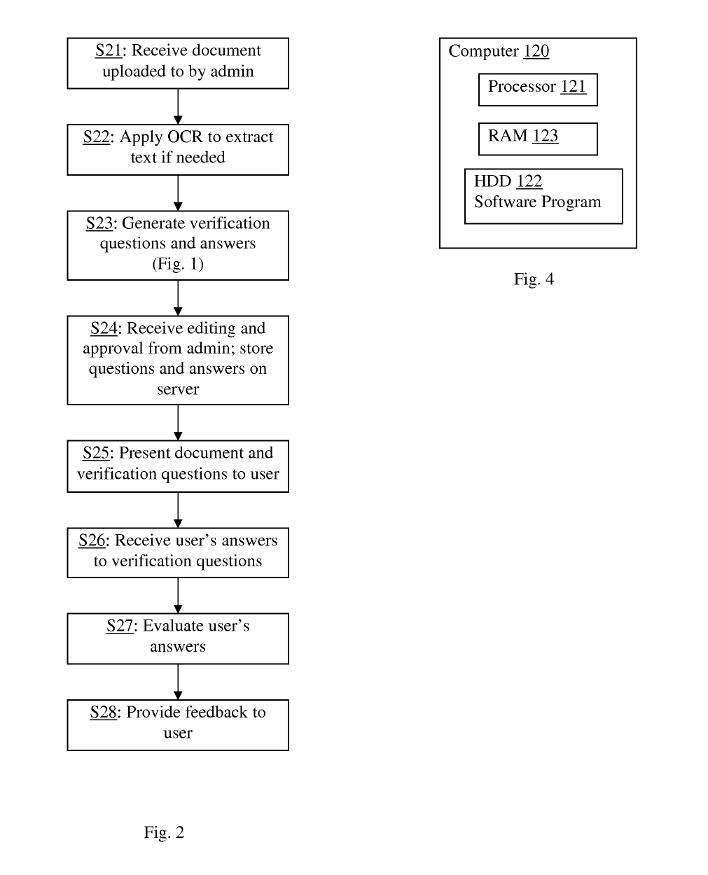

These various types of verification questions can be generated automatically by applying a syntactic analysis to the document text, in a process schematically illustrated in FIG. 1 and described below. First, the document text is parsed into separate statements (step S101). A statement is typically a sentence, but can also be a part of a sentence, multiple sentences, etc. A selected number of statements, which will be used to generate verification questions, are further parsed into separate words or phrases (step S102). The selection of the statements may be random. Alternatively, statements can be selected according to pre-defined rules. For instance, the first and/or last sentence in a paragraph may be selected. As another example, the selection of the sentences can be achieved by analyzing the text. In case the text has a title, sentences can be analyzed to find those including the same or similar word used in a title of the text. As another example, a whole of the document may be analyzed to find frequently used words, and sentences including such frequently used words may be selected. In case of the document relates to a historical subject, a sentence may be analyzed to find those including both of a proper nouns and four digits (highly expected to be a dominical year) for such selection. Known techniques are available for parsing text into statements and parsing statements into words. Any suitable algorithm may be used in these steps.

Then, for each selected statement, a word or phrase is selected and its grammatical category is determined (step S103) in order to generate a verification question. The grammatical categories include (1) nouns and proper nouns, (2) numerical values, (3) verbs, (4) adjectives and adverbs, etc. FIG. 3B shows an example of two sentences and how each word/phrase may be categorized. Such categorization may be done by using a dictionary.

Depending on the grammatical category of the selected word/phrase, the word/phrase can be used to generate a verification question as follows (steps S104 to S113):

Noun or proper noun (step S104): The word can be used to generate a fill-in-the-blank question and the associated correct answer (step S108). As mentioned earlier, this is done by generating a modified statement where the keyword is omitted to form a blank. Note here that for the purpose of step S104, numerical values and not considered nouns.

Numerical value (step S105), e.g. price, number, date, etc.: The word can be used to generate a fill-in-the-blank question (step S108), a multiple-choice question (step S109) or a true/false question (step S110), and the associated correct answer. Which of the three types of questions is generated may be determined randomly, or based on a suitable rule. To generate a true/false question, the word is either kept as-is or replaced with another numerical value (step S111). To generate a multiple-choice question, a modified statement is generated by omitting the word and a list of choices is also generated that includes various different values.

Verb (step S106): The word can be used as-is or negated (step S112) to generate a true/false question and the associated correct answer (step S110).

Adjective or adverb (step S107): The word can be used as-is or replaced with an antonym (step S113) to generate a true/false question and the associated correct answer (step S110).

If the selected word/phrase is none of the above, it may be a common word such as preposition, conjunction, article, pronoun, etc., which generally can be ignored. In such a case, the process goes back to step S103 to examine another word/phrase in the statement and to attempt to generate a verification question (step S114).

If a verification question is successfully generated in step S108, S109 or S110, the process goes back to step S103 to process the next selected statement (step S115).

As the result of this process, a set of verification questions and their associated correct answers are generated.

FIG. 2 schematically illustrates an overall process of automatically generating and using verification questions according to an embodiment of the present invention. First, an administrator uploads a document to the server computer, e.g. a server which hosts a website or web portal (step S21). If the document is originally in a non-parsable format, such as a scanned image, the server processes it by an OCR (optical character recognition) technique to extract the text (step S22). Then, the process for automatically generating verification questions and associated correct answers, shown in FIG. 1, is applied to the document text (step S23). Once a set of verification questions and associated correct answers have been generated by step S23, an administrator can edit (including modifying, adding, deleting) the automatically generated questions and answers, and approve them, and the set of verification questions and associated correct answers are stored on the server (step S24). Administrator's editing and approval are optional.

The document is presented to users to read, and the set of verification questions (quiz) is also presented to the users (step S25). The manner of presenting the document and the quiz to the users is not limited to any specific way. For example, web links may be provided to the users to access the document and/or the quiz online, or the document and/or the quiz may be distributed to the users by email, etc. The document and the quiz may be presented to a user at the same time (e.g. available on the same web page), or the quiz may be presented after the document is presented, etc. Preferably, the quiz is presented in a form (e.g., by using web tools) that allows the user to enter answers via electronic means and allows the server to evaluate and/or record each user's answers. After a user takes the quiz and provides the answers (step S26), the answers are automatically evaluated by comparing them to the correct answers generated in step S23 (or edited by admin in step S24) (step S27). Feedback may be presented to the user, such as the number of questions the user answered correctly, the correct answer to the questions, and/or a request for the user to re-read the material, etc. (step S28). Because the user's answers are evaluated automatically by the server, the feedback can be instantaneous as soon as the user completes the quiz. Steps S25 to S28, which pertain to administering the quiz, can be implemented by any suitable software techniques, for example, using web-based programs.

The method of automatically generating verification questions (quiz) and administering the quiz to users can be practiced in several different ways. First, the process of automatically generating verification questions and answers for a document, i.e., steps S21 to S23 (as well as optional step S24), is performed once, and the quiz generated by this process is stored on the server. Then, the stored quiz can be administered to multiple users. Thus, steps S25 to S28 will be performed repeatedly for the multiple users as needed. In this approach, the same quiz is administered to all users.

In a second approach, after the document is uploaded and OCRed if necessary (steps S21 and S22), the process of generating verification questions and answers (step S23) is performed dynamically as the quiz is administered to each user. In other words, steps S23 and S25 to S28 are performed repeatedly for the multiple users as needed. For this approach, the automatic quiz generation method (FIG. 1) may have randomness built into it, so that the quizzes administered to different users may be different. For example, the selection of multiple statements from the document (step S102), the selection of the word/phrase in a statement to be used as the basis for the question (step S103), the choice of whether to keep or negate/replace a word or phrase (steps S111, S112 and S113), and the choice of what type of question to generate using a numerical value (step S105), can be made using random numbers or using parameters that change from user to user or from time to time.

In a third approach, the process of automatically generating verification questions and answers for a document, steps S21 to S23 (as well as optional step S24), is performed once, and a superset of a large number of verification questions and answers is generated and stored. For example, it is possible to generate one question from each statement in the document. Then, when administering the quiz to a user (step S25), a subset of the verification questions is selected (e.g. randomly) and presented to the user. As a result, the quizzes administered to different users may be different.

After the quiz is administered to a sufficient number of users, the users' answers may be analyzed to generate useful statistics. For example, statistics regarding verification questions that have been answered incorrectly may be used to modify or clarify certain sections of the document. This is particularly true with the second and third approaches described above, because the automatically generated questions potentially cover all or most of the statements in the document.

It can be seen that the above-described method for automatically generating verification questions and answers (FIG. 1) is based purely on a syntactic analysis of the document text; no prior knowledge of the content of the document is required.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method implemented in a data processing apparatus for automatically processing text of a document to generate verification questions and associated correct answers, comprising:
(a) parsing the text into statements and selecting a plurality of the statements; and
(b) for each selected statement, generating a verification question and associated correct answer by performing one of the following steps:
(b1) generating a modified statement by omitting one or more selected words or phrases from the statement and inserting blanks in their places, wherein the modified statement constitutes a fill-in-the-blank type of verification question and the omitted words or phrases constitutes the associated correct answer;
(b2) either modifying the statement by replacing a selected word or phrase in the statement with another word or phrase that is a negated form or an antonym of the selected word or phrase, or keeping the statement unmodified, wherein the modified or unmodified statement constitutes a true/false type of verification question and the associated correct answer is False if the statement is modified and True if the statement is unmodified; and
(b3) generating a modified statement by omitting one or more selected words or phrases from the statement and inserting blanks in their places, and generating a list of choices for each blank including a correct choice and one or more incorrect choices, wherein the modified statement and the lists of choices constitute a multiple-choice type of verification question and the correct choices constitute the associated correct answer;
whereby a plurality of verification questions and associated correct answers are generated.

2. The method of claim 1, wherein step (b) further comprises:
parsing the statement into a plurality of words or phrases; and
categorizing a selected one of the words or phrases into one of a plurality of grammatical categories comprising noun, proper noun, numerical value, verb, adjective, adverb, and common word,
wherein if the word or phrase is a noun or proper noun, step (b1) is performed,
if the word or phrase is a numerical value, step (b1), (b2) or (b3) is performed,
if the word or phrase is a verb, step (b2) is performed by replacing the verb with its negated form or keeping the statement unmodified,
if the word or phrase is an adjective or adverb, step (b2) is performed by replacing the adjective or adverb with an antonym or keeping the statement unmodified, and
if the word is a common word, repeating the categorizing step using another selected one of the words or phrases.

3. The method of claim 1, further comprising:
receiving editing input from an administrator; and
modifying some of the verification questions based on the editing input.

4. The method of claim 1, further comprising:
(c) presenting the document and the plurality of verification questions generated in step (b) to a user;
(d) receiving from the user a plurality of answers to the plurality of verification questions;
(e) evaluating the answers received from the user by comparing the received answers to the correct answers generated in step (b); and
(f) providing feedback to the user based on the evaluation.

5. The method of claim 4, wherein step (b) is performed once, the verification questions and associated correct answers are stored, and steps (c) to (f) are repeated multiple times for multiple users using the stored verification questions and associated correct answers.

6. The method of claim 4, wherein steps (b) to (f) are repeated multiple times for multiple users.

7. The method of claim 6, wherein step (b) is performed once to generate a superset of verification questions and associated correct answers, and steps (c) to (f) are repeated multiple times for multiple users, each time using a subset of the superset of verification questions and associated correct answers.

8. A computer program product comprising a computer usable non-transitory medium having a computer readable program code embedded therein for controlling a data processing apparatus, the computer readable program code configured to cause the data processing apparatus to execute a process for automatically processing text of a document to generate verification questions and associated correct answers, the process comprising:
(a) parsing the text into statements and selecting a plurality of the statements; and
(b) for each selected statement, generating a verification question and associated correct answer by performing one of the following steps:
(b1) generating a modified statement by omitting one or more selected words or phrases from the statement and inserting blanks in their places, wherein the modified statement constitutes a fill-in-the-blank type of verification question and the omitted words or phrases constitutes the associated correct answer;
(b2) either modifying the statement by replacing a selected word or phrase in the statement with another word or phrase that is a negated form or an antonym of the selected word or phrase, or keeping the statement unmodified, wherein the modified or unmodified statement constitutes a true/false type of verification question and the associated correct answer is False if the statement is modified and True if the statement is unmodified; and
(b3) generating a modified statement by omitting one or more selected words or phrases from the statement and inserting blanks in their places, and generating a list of choices for each blank including a correct choice and one or more incorrect choices, wherein the modified statement and the lists of choices constitute a multiple-choice type of verification question and the correct choices constitute the associated correct answer;
whereby a plurality of verification questions and associated correct answers are generated.

9. The computer program product of claim 8, wherein step (b) further comprises:
parsing the statement into a plurality of words or phrases; and
categorizing a selected one of the words or phrases into one of a plurality of grammatical categories comprising noun, proper noun, numerical value, verb, adjective, adverb, and common word,
wherein if the word or phrase is a noun or proper noun, step (b1) is performed,
if the word or phrase is a numerical value, step (b1), (b2) or (b3) is performed,
if the word or phrase is a verb, step (b2) is performed by replacing the verb with its negated form or keeping the statement unmodified,
if the word or phrase is an adjective or adverb, step (b2) is performed by replacing the adjective or adverb with an antonym or keeping the statement unmodified, and
if the word is a common word, repeating the categorizing step using another selected one of the words or phrases.

10. The computer program product of claim 8, wherein the process further comprises:
receiving editing input from an administrator; and
modifying some of the verification questions based on the editing input.

11. The computer program product of claim 8, wherein the process further comprises:
(c) presenting the document and the plurality of verification questions generated in step (b) to a user;
(d) receiving from the user a plurality of answers to the plurality of verification questions;
(e) evaluating the answers received from the user by comparing the received answers to the correct answers generated in step (b); and
(f) providing feedback to the user based on the evaluation.

12. The computer program product of claim 11, wherein step (b) is performed once, the verification questions and associated correct answers are stored, and steps (c) to (f) are repeated multiple times for multiple users using the stored verification questions and associated correct answers.

13. The computer program product of claim 11, wherein steps (b) to (f) are repeated multiple times for multiple users.

14. The computer program product of claim 6, wherein step (b) is performed once to generate a superset of verification questions and associated correct answers, and steps (c) to (f) are repeated multiple times for multiple users, each time using a subset of the superset of verification questions and associated correct answers.
